(19) United States
(12) Patent Application Publication
(10) Pub. No.: US 2010/0187489 A1
(43) Pub. Date: Jul. 29, 2010

(54) CONNECTOR ASSEMBLY FOR A TRAILER

(76) Inventor: Michael Hebert, Marrero, LA (US)

Correspondence Address: Keaty Law Firm;One Canal Place, Suite 2410, 365 Canal Street, New Orleans, LA, 70130, US

(21) Appl. No.: 12/452,976

(22) PCT Filed: Aug. 3, 2007
(86) PCT No.: PCT/US07/17471

§ 371 Date: Mar. 5, 2010

(51) Int. Cl. B60D 1/66; B60S 9/14; B60D 1/36

(52) U.S. Cl. 254/420; 280/475; 280/477

(57) ABSTRACT

A connector assembly for mounting on a connector arm of a trailer to facilitate easy alignment of the trailer connector arm with a hitch of a towing vehicle. The connector assembly can move the connector arm up and down, side-to-side and drive forward and reverse in relation to the towing vehicle.

### BACKGROUND OF THE INVENTION

This invention relates to towing vehicles, and more particularly to a system for aligning a connector on a trailer with a hitch on a tow vehicle.

When securing a trailer to a towing vehicle an operator has to align the mating parts on a trailer and a towing vehicle. Conventionally, the boats are transported on a special trailer that has a large support portion that generally supports the entire length of the boat. A towing arm extends forwardly from the support portion; the towing arm has a trailer connector that can be engaged with a hitch of a towing vehicle. Conventional towing arms comprise an elongated member that is fixedly connected to the support portion.

Since the towing vehicles vary in size and height, the hitch can be located above or below the trailer connector. The trailer with the boat weighs hundreds of pounds and is unwieldy. The fixed towing arm makes it difficult to align the trailer connector with the hitch and many boaters have to move their vehicles several times left or right and forward or backward to allow the trailer connector to be engaged with the hitch of the towing vehicle. This process can be time consuming and awkward, particularly since the driver of the towing vehicle cannot see the towing arm over the hood of the vehicle.

An alternative would be to walk around the towing vehicle after each segment of movement to determine how close to (or how far from) being properly aligned the mating hitch and the trailer connector are. Usually it takes several attempts to properly align the truck with the trailer before proper alignment is achieved. The process can be somewhat expedited if the driver has an assistant who could give directions to the driver while standing outside of the vehicle.

The present invention contemplates elimination of drawbacks associated with conventional boat trailer connectors and provision of a boat trailer that has a connector arm that can be moved along a vertical axis and steered side-to-side and backwards and forward.

### SUMMARY OF THE INVENTION

It is therefore an object of the present invention to provide a trailer assembly that can be detachably engaged with a hitch on a towing vehicle with relative ease when operated by a single person.

It is another object of the present invention to provide a trailer assembly that can be used with boat trailers and the like.

It is a further object of the present invention to provide a trailer assembly that can be pivoted for storage while mounted on a connector arm of a trailer.

It is yet another object of the present invention to provide a trailer assembly that is simple to operate and use without any specialized training.

These and other objects of the present invention are achieved through a provision of a connector assembly for a trailer having an elongate connector arm with a front end configured for attachment to a towing vehicle. The connector assembly is detachably mounted on the connector arm. The mounting means can be U-bolts engaging the connector arm and retained thereon by bolts and nuts.

A drive assembly is pivotally engaged with the mounting means. The drive means is adapted and configured for moving the connector arm toward and away from the towing vehicle. The drive assembly comprises a drive shaft extending in a drive shaft housing, a rotating wheel secured to a lower end of the drive shaft and a hand-operated crank shaft for imparting rotation on the rotating wheel through a gear assembly. In other embodiments, the hand-operated crank can be replaced with an electric motor powered by the towing vehicle battery.

A steering assembly is secured to the drive shaft housing for directing side-to-side movement of the drive assembly. The steering assembly comprises a collar secured on the drive shaft housing and a steering handle that an operator can pivot and thereby impart the movement to the drive assembly. In some of the embodiments, the steering handle can be replaced with a steering motor.

An elevating assembly is secured on the drive shaft housing; the elevating assembly is adapted and configured for raising and lowering the connector arm in relation to the towing vehicle. The elevating assembly comprises a rack mounted on the outside wall of the drive shaft housing and a pinion assembly that moves along the rack for raising and lowering the connector arm. The pinion assembly can be moved by a handle or by a motor, depending on the embodiment of the connector assembly of the present invention. The motors can be controlled by a remote control member that is provided with suitable knobs for steering, elevating/lowering and moving the connector arm forward and reverse.

The connector assembly of the present invention can be moved between an operational position when the drive shaft housing extends transverse to the elongate connector arm and a stowed position when the drive shaft housing is pivoted to extend in a generally parallel relationship to the connector arm.

### BRIEF DESCRIPTION OF THE DRAWINGS

Reference will now be made to the drawings, wherein like parts are designated by like numerals, and wherein

FIG. 1 is a perspective view of the first embodiment of the trailer connector assembly according to the present invention in an operating position.

FIG. 2 is perspective view of the first embodiment of the trailer connector assembly according to the present invention in a folded position.

FIG. 3 is an exploded detail view of the drive assembly employed in the first embodiment of the apparatus of the present invention.

FIG. 4 is an exploded detail view illustrating a part of the drive assembly employed in the first embodiment of the apparatus of the present invention.

FIG. 5 is an exploded detail view of the steering assembly employed in the first embodiment of the apparatus of the present invention.

FIG. 6 is an exploded detail view of the tilt assembly employed in the first embodiment of the apparatus of the present invention.

FIG. 7 is a perspective view of the trailer connector assembly of the second embodiment of the present invention.

FIG. 8 is a perspective view of the trailer connector assembly of the third embodiment of the present invention engaged with a hitch of a towing vehicle.

FIG. 9 is a detail view of a remote control for use with the third embodiment of the apparatus of the present invention.

FIG. 10 is a perspective view of the trailer connector assembly of the third embodiment of the present invention.

FIG. 11 is a detail view of the drive wheel assembly of the third embodiment of the present invention.

FIG. 12 is a perspective view of the trailer connector assembly of the third embodiment of the present invention in a stowed position.

FIG. 13 is a detail view showing a pin that can be disengaged to allow tilting of the connector assembly.

FIG. 14 is an exploded detail view of the steering and wheel drive assembly of the third embodiment of the present invention.

FIG. 15 is a cutaway detail view of the steering drive.

FIG. 16 is a cutaway detail view of the wheel drive.

### DETAIL DESCRIPTION OF THE PREFERRED EMBODIMENT

Turning now to the drawings in more detail, numeral 10 designates the trailer connector assembly of the first embodiment of the present invention. The trailer connector assembly 10 is adapted for securing on a connector arm 12 of a trailer 14. The connector assembly 10 comprises a drive assembly 20, a steering assembly 22 and a tilt assembly 24, which in combination provide motion flexibility to the connector assembly 10 and allow the connector assembly to move along a vertical axis, side-to-side and forward and backward.

Turning to FIG. 6, the tilt assembly 24 is shown in more detail. The tilt assembly 24 comprises a mounting means, which secures the connector assembly 10 on the connector arm 12. In this embodiment, the mounting means comprises a pair of U-shaped bolts 26 that have their free ends 27, 28 extend around the connector arm 12 and engage with a tilt base plate 30 through corresponding aligned openings 31, 32. The bolts 31, 32 are secured to the tilt base plate by washers 33 and nuts 35 that are attached to the free ends 27, 28. The tilt base plate 30 has an inner surface that contacts the connector arm 12 when the assembly 10 is mounted on the connector arm, and an outer surface, which faces away from the connector arm 12.

A central opening 34 is made in the tilt base plate 30 and a cylindrical collar 36 is secured therein. The collar 36 extends outwardly from the outer surface of the tilt base plate; the collar being provided with a circumferential groove for receiving a retaining ring 40 therein. The tilt assembly further comprises a tilting plate 42 that is configured for mounting on the collar 36. A central opening 44 made in the tilting plate 42 receives a portion of the collar 36, when the plates 30 and 42 are placed against each other.

The tilting plate 42 has an inner surface, which contacts the outer surface of the tilt base plate 30 and an outer surface, away from the tilt base plate 30. The tilting plate 42 carries a pair of brackets 45, 46 that are secured transversely to the outer surface of the tilting plate 42. The brackets 45, 46 are each provided with a cutout for receiving a portion of a housing 60 of the drive assembly 20.

The tilt base plate 30 is provided with a pair of opposing openings 38, 39 for receiving an end of a pull tilt pin 50. The pull tilt pin 50 extends through an opening formed in an L-shaped bracket 52, which is secured to the outer surface of the tilting plate 42. An aligned opening 54 is formed in the tilting plate 42 to allow extension of the end of the tilting pin into the opposing opening 38 or 39 depending on the position of the tilting plate 42 in relation to the tilt base plate 30. A compression spring 56 is mounted on the end of the pull tilt pin 50 and is retained in place by a retaining ring 58. The spring 56 normally urges the pivot pin 50 into a locking engagement with the tilt base plate 30. When the pin 50 is pulled from the opening 38 against the resistance of the compression spring 56 the tilting plate 42 can be rotated 180 degrees allowing tilting of the connector assembly 10. When the pin 50 is released, the spring 56 causes the end of the pin 50 to engage with the opposing opening 39, thereby allowing the connector assembly 10 to move between two alternative tilt positions.

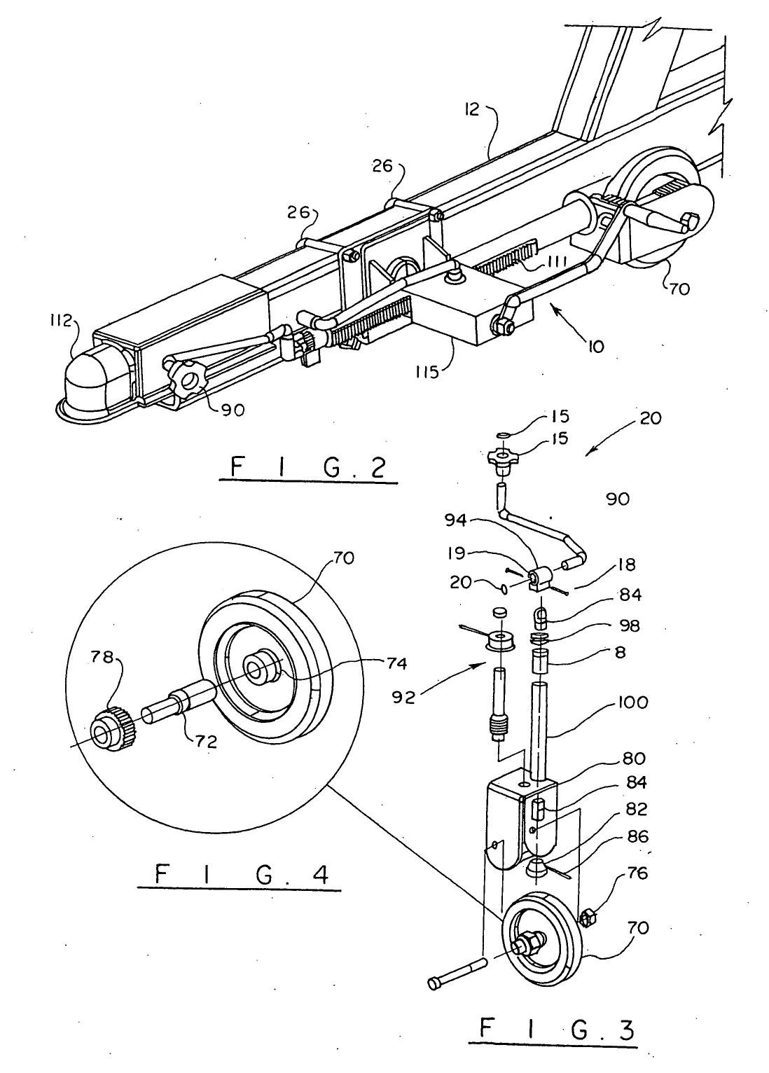

The drive assembly 20 shown in FIGS. 3 and 4 illustrates one of the embodiments of a drive assembly that can be utilized in the present invention. The drive assembly 20 comprises a rotating wheel 70, which is secured for rotation on an axle tube 72. A driven worm gear 78 is positioned on the axle tube 72. The axle tube is positioned for rotation within a yoke 80 of the steering assembly 22 and is secured thereto by an axle bolt 74, which carries a securing nut 76 on a free end. The driven worm gear 78 is operationally connected to a pinion gear, or driving gear wheel 82 that is secured to a lower end of a drive shaft 84. A retaining pin 86 retains the gear 82 on the drive shaft 84.

A hand crank 90 is operationally connected to the drive shaft 84 through a worm gear/pinion gear assembly 92. A crank adapter 94 is sandwiched between the drive shaft 84 and the hand crank 90. A knob 96 can be secured on top of the hand crank 90 to facilitate gripping of the hand crank by a user. A drive shaft bearing 98 can be provided in a surrounding relationship over the drive shaft 84. The drive shaft 82 extends within a cylindrical housing 100 that is secured to the top of the yoke 80. Rotation imparted on the hand crank 90 is transmitted to the drive shaft 82 and through the gear assemblies—to the rotating wheel 70, allowing the drive assembly to move toward and away from the towing vehicle in the hitch-to-connector alignment process.

The drive shaft housing 100 is provided with a rack 111 positioned on the outside surface of the housing. Rack-engaging pinion gear (not shown) is positioned, within a housing 115 to allow up and down movement of the drive wheel assembly 20. A handle 117 can be gripped by a user and manipulated to cause the teeth of the pinion mounted inside the housing 115 to move up and down along the rack 111.

The steering assembly 22 comprises a steering tiller handle 110, one end of which is received within a cylindrical adapter 112. A retainer cap 114 prevents disengagement of the steering tiller handle 110 from the adapter 112. The adapter 112 is secured to a mounting yoke 114, which is positioned in a surrounding relationship over an upper end of the drive shaft housing 100. A lower thrust bearing 116 is secured on the housing 100; an upper steering bearing 118 rests on a top edge of the housing 100 above the rack 111. The steering tiller handle 110 allows an operator to pivot and steer the drive assembly 20 and the connector arm 12 along with the trailer 14 side-to-side to properly align the connector arm 12 with the hitch of the towing vehicle.

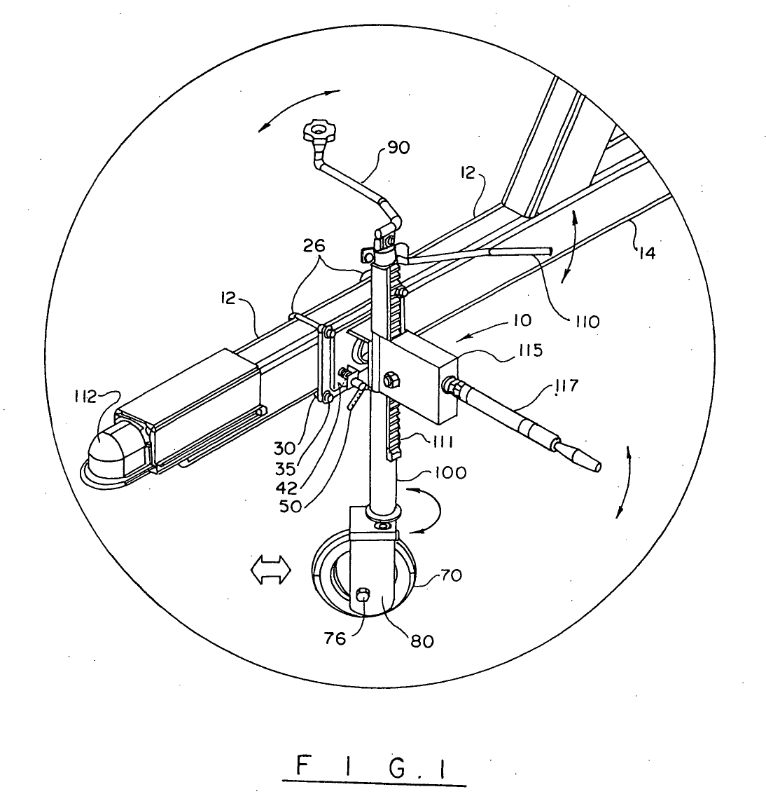

When the connector assembly 10 is in its lowered, operational position shown in FIG. 1 the wheel 70 rests on the ground. The trailer has two wheels positioned in the rear part of the trailer. As a result, the trailer rests on three wheels, one wheel is provided by the trailer connector 10, while two others—are standard equipment on the trailer. The operator can easily move the connector arm 12 up and down, rotate the arm 12 about a vertical axis and move the wheel 70 forward toward the towing vehicle and back. As a result, the trailer connector arm 12 can be easily manipulated to move closer in alignment with the hitch of the towing vehicle and allow the cup 112 to be engaged with the hitch.

During transportation of the trailer, the connector assembly can be moved to a stowed position, shown in FIG. 2. The operator pulls the pin 50, releasing engagement of the tilting plate 42 from the tilt base plate 30 and pivots the entire connector assembly about 90 degrees. The operator then releases the pin 50 and allows it to engage the opposing opening 38 or 39 and secure the connector assembly 10 in the stowed position.

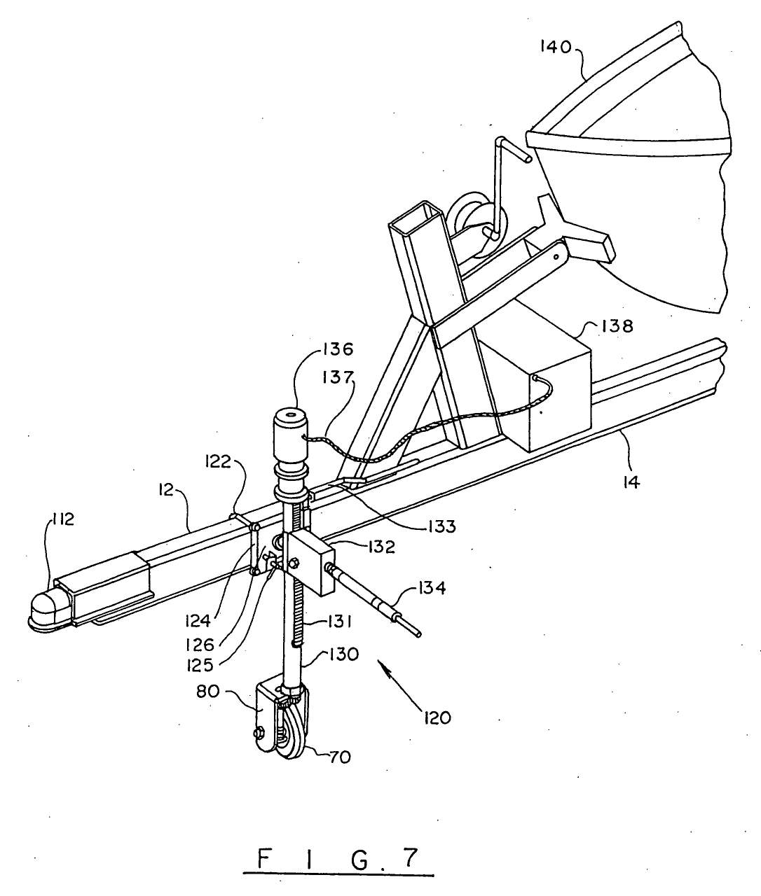

Turning now to the second embodiment shown in FIG. 7, the connector assembly 120 is shown to comprise a similar mounting assembly comprised of one or more mounting U-bolts 122 engageable with the a base plate 124 and a tilting plate 126. A pull tilt pin 125 functions in a manner similar to the tilt pin 50. A drive shaft is positioned in a housing 130, the outside of which carries a rack 131. A mating pinion/gear is positioned in a housing 132, and a handle 134 is provided for moving the pinion/gear along the rack 131.

In this embodiment, the hand-operated crank and drive assembly is replaced with a motor 136, which is mounted in operational connection with the rotating wheel 70. The motor 136 is powered by a battery 138, which can be positioned on the trailer 14. A suitable wiring 137 connects the motor 136 with the battery 138 to facilitate movement of the connector assembly 120 toward and away from the hitch of the towing vehicle. Similarly to the connector assembly 10, the connector assembly 120 can move along a vertical axis up and down through the use of the rack and pinion assembly 131, 132 and side-to-side through the use of a hand steering handle that is secured on the drive shaft housing 130. The connector assembly also allows the connector arm 12 to move front and backwards by using the drive assembly with the motor 136 and the rotating wheel 70. The trailer 14 can be used for transporting a boat 140 or other necessary cargo.

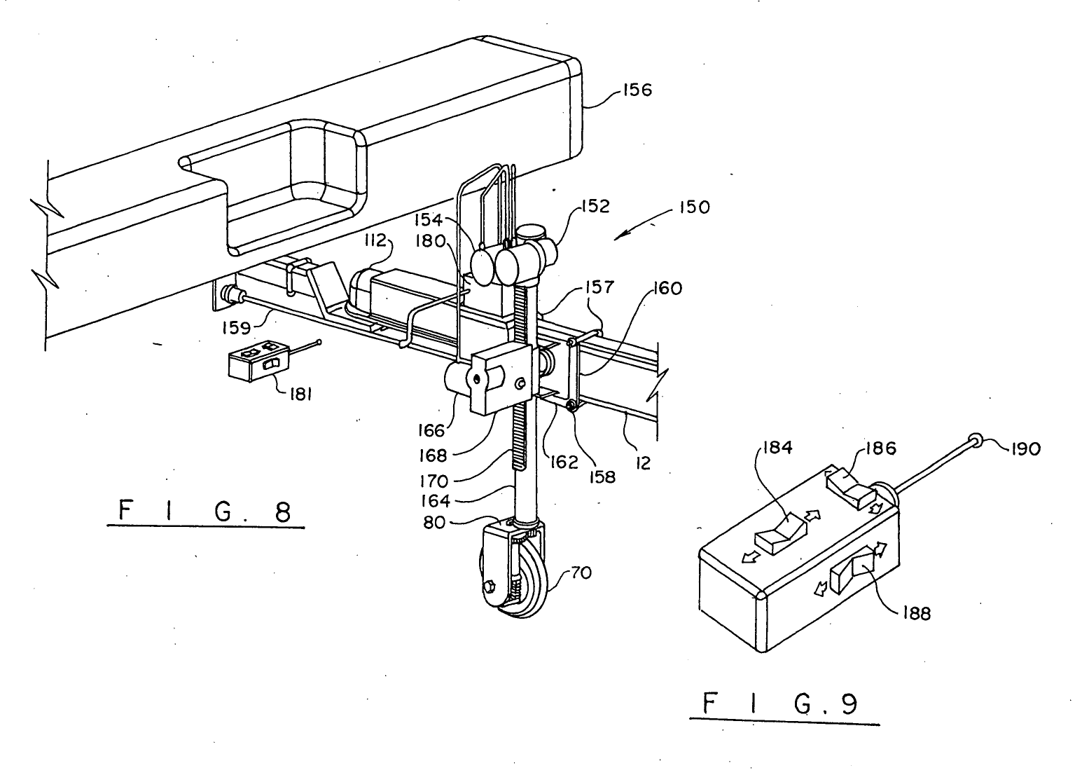

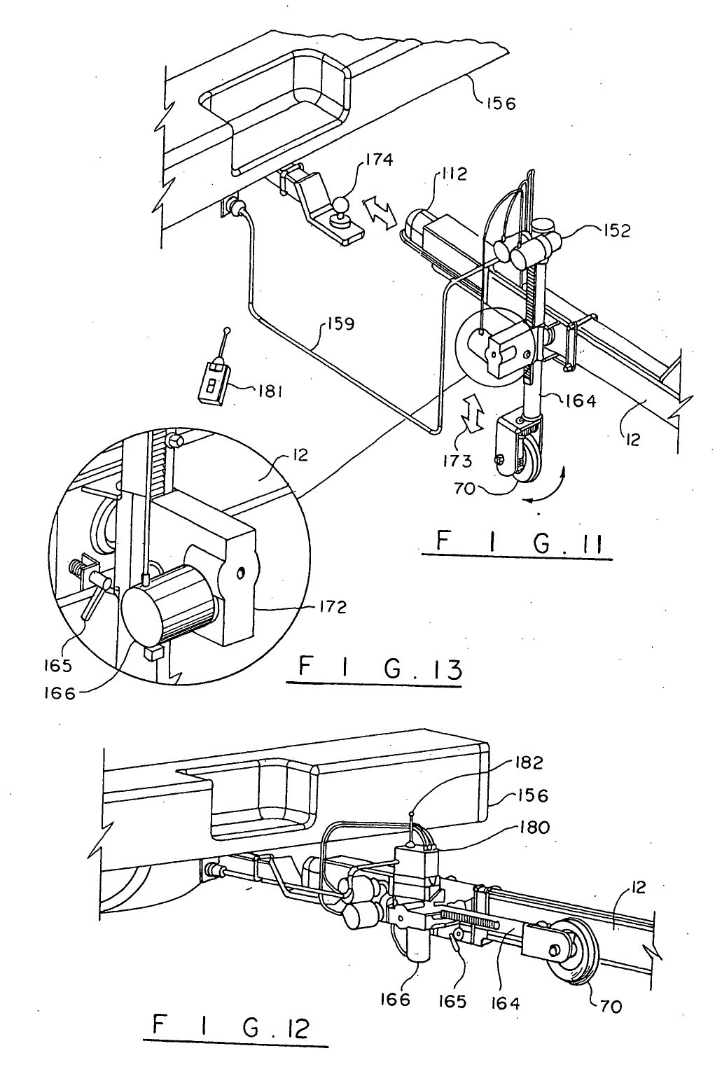

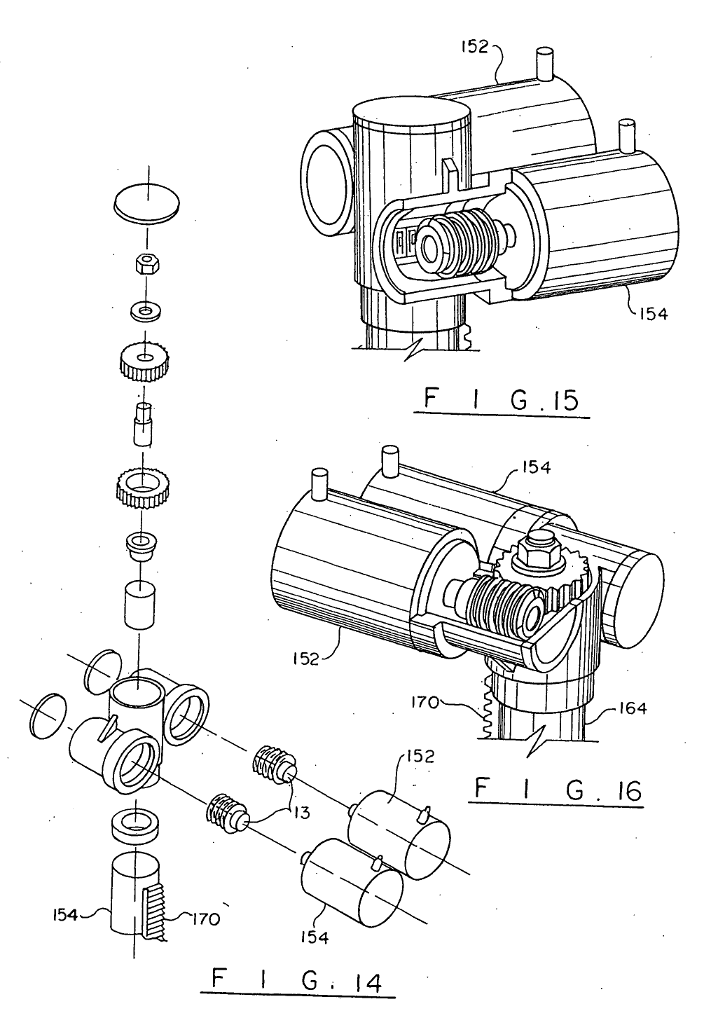

FIGS. 8-16 illustrate the third embodiment of the apparatus of the present invention, which is generally designated by numeral 150. This embodiment employs a pair of motors, a drive wheel motor 152 and a steering motor 154 to drive and steer the connector assembly and thus the connector arm 12 for proper alignment with a hitch of a towing vehicle 156. The motors 152, 154 are operationally connected to a power source of the vehicle 156 through a suitable cable assembly 159.

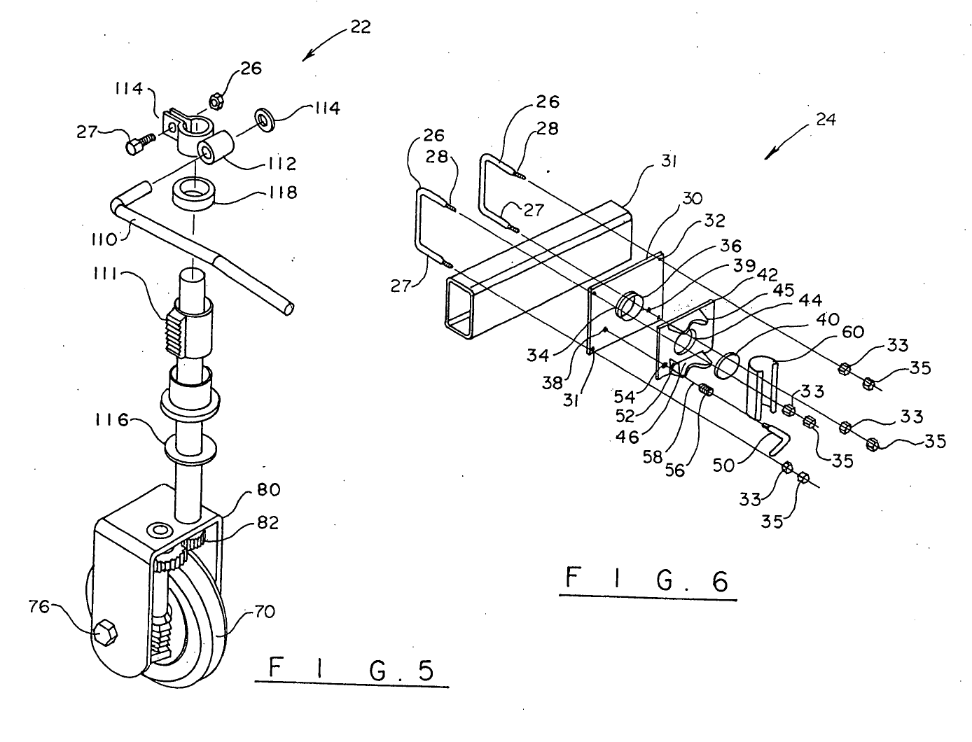

Similarly to the embodiments of FIGS. 1-7, the connector assembly 150 can be mounted on the connector arm 12 of the trailer 14 by the mounting means 157, which can be a pair of U-bolts that are secured on the connector arm 12 by bolts 158 or other suitable securing means. The ends of the U-bolts extend through corresponding openings formed in the tilt base plate 160, which is engaged with the pivotally rotatable tilting plate 162.

A drive shaft housing 164 is secured to the tilting plate 162 allowing the housing 164 to be moved between a first position where the wheel 70 contacts the ground (FIG. 8) and a second, stowed position (FIG. 12) when the housing 164 extends in a substantially parallel relationship to the connector arm 12. A spring-loaded tilting pin 165 can be pulled to release the tilting plate 162 to allow the housing 164 to be tilted into the stowed position.

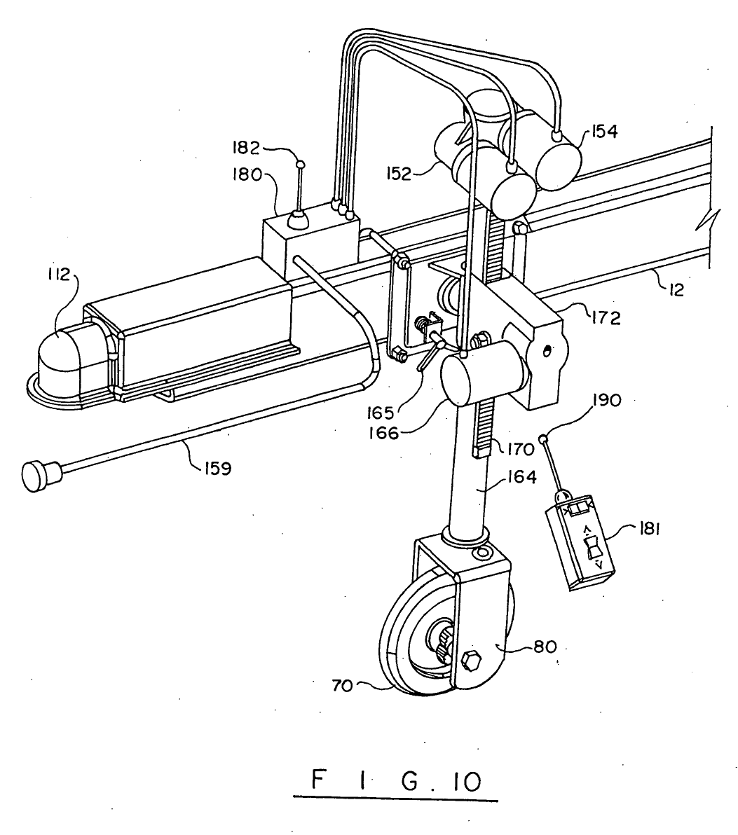

A third motor 166 is operationally connected to a rack and pinion elevating assembly 168, which comprises a rack 170 mounted on the outside of the drive shaft housing 164 and a pinion drive positioned in a housing 172. The pinion drive is adapted for engagement with the rack 170 when raising or lowering the connector arm 12 in relation to the hitch of the towing vehicle, generally in the direction of arrows 173 (FIG. 11) to facilitate alignment of the attached connector arm 12 to a hitch 174 of the towing vehicle 156. The motor 166 is connected to the power source of the towing vehicle via the cable 159.

A control unit 180 with an antenna 182 controls operation of the motors 152, 154 and 166. The control unit 180 is connected to the same power source of the towing vehicle through the cable 159 that supplies power to the motors 152, 154 and 166. A remote control member 181 is provided for transmitting a remote signal to the control unit 180. The remote control member may send a radio or wireless signal to the control unit 180. A first switch 184 is provided on the remote control member 182 to control the drive motor 152; a second switch 186 is provided for controlling the steering motor 154, and a third switch 188 is provided for controlling the elevating motor 166. An antenna 190 mounted on the housing of the remote control member 182 transmits the signal to the antenna 182 of the control unit 182 to energize the motor 154 and cause the connector arm to pull the trailer forward or push in reverse; to energize the motor 154 to steer the connector arm 12 left or right; and to energize the motor 166 to elevate or lower the connector arm 12.

By manipulating the buttons of the remote control member, the operator can move the trailer 14 to achieve the alignment of the cap 112 with the towing vehicle hitch 174. The operator can then secure the trailer connector arm 12 to the towing vehicle in the conventional manner. Once the connector arm 12 is secured, the operator can then pivot the connector assembly 150 into a stowed position and transport the cargo on the trailer 14 to its destination.

Many changes and modifications can be made in the design of the present invention without departing from the spirit thereof. Although embodiments of various methods and devices are described herein in detail with reference to certain versions, it should be appreciated that other versions, embodiments, methods of use, and combinations thereof are also possible. Therefore the spirit and scope of the appended claims should not be limited to the description of the embodiments contained herein.

I claim:

1. A connector assembly for a trailer having an elongate connector arm with a front end configured for attachment to a towing vehicle, the connector assembly comprising:
a means for mounting the connector assembly on the connector arm;
a drive assembly pivotally engaged with the mounting means and capable of moving the connector arm toward and away from the towing vehicle;
a steering assembly mounted on the drive assembly for directing side-to-side movement of the drive assembly; and
an elevating assembly secured on the drive assembly and capable of raising and lowering the connector arm in relation to the towing vehicle.

2. The apparatus of claim 1, wherein said mounting means comprises at least one mounting member engageable with the connector arm and the drive assembly.

3. The apparatus of claim 1, wherein said drive assembly comprises an elongate drive shaft mounted in a drive shaft housing and a rotating wheel carried by a lower end of the rotating shaft.

4. The apparatus of claim 3, further comprising a means for moving the drive assembly between an operating position when the drive shaft housing is oriented transverse to the connector arm and a stowaway position wherein the drive shaft housing extends in a substantially parallel relationship to a longitudinal axis of the connector arm.

5. The apparatus of claim 4, wherein said means for moving the drive assembly between an operating position and a stowaway position comprises a tilt base plate secured to the mounting means, a tilting plate pivotally engaged with the tilt base plate and secured to the drive shaft housing, and a pivot pin selectively engageable with the tilt base plate and the tilting plate.

6. The apparatus of claim 5, wherein said pivot pin carries a compression spring normally urging the pivot pin into a locking engagement with the tilt base plate.

7. The apparatus of claim 3, wherein said drive assembly further comprises a means for imparting rotation to said rotating wheel.

8. The apparatus of claim 7, wherein said rotation imparting means comprises a hand crank connected to the drive shaft and extending outwardly from the drive shaft housing and a gear assembly mounted between the drive shaft and the rotating wheel.

9. The apparatus of claim 7, wherein said rotation imparting means comprises a drive motor powered by an external power means.

10. The apparatus of claim 9, wherein said steering assembly comprises a collar secured on said drive shaft housing and a means for transmitting directional force to the drive shaft housing.

11. The apparatus of claim 10, wherein said means for transmitting directional force comprises a handle attached to the collar.

12. The apparatus of claim 10, wherein said means for transmitting directional force comprises a steering motor powered by an external power means.

13. The apparatus of claim 12, wherein said elevating means comprises a rack mounted on an outside of the drive shaft housing and a pinion assembly for elevating and lowering the drive shaft housing in relation to the towing vehicle.

14. The apparatus of claim 13, further comprising a handle for moving the pinion assembly along the rack.

15. The apparatus of claim 13, further comprising an elevating motor for moving the pinion assembly in relation to the rack.

16. The apparatus of claim 15, further comprising a remote control means for controlling operation of said drive motor, said steering motor and said elevating motor.

17. The apparatus of claim 16, wherein said remote control means comprises a control unit operationally connected to the drive motor, the steering motor and the elevating motor, and a remote control unit for transmitting a control signal to the control unit.

18. A connector assembly for a trailer having an elongate connector arm with a front end configured for attachment to a towing vehicle, the connector assembly comprising:
a means for detachably mounting the connector assembly on the connector arm;
a drive assembly pivotally engaged with the mounting means and capable of moving the connector arm toward and away from the towing vehicle, said drive assembly comprising a drive shaft extending in a drive shaft housing, a rotating wheel secured to a lower end of the drive shaft and a hand-operated crank shaft for imparting rotation on the rotating wheel through a gear assembly;
a steering assembly secured to the drive shaft housing for directing side-to-side movement of the drive assembly; and
an elevating assembly secured on the drive shaft housing and capable of raising and lowering the connector arm in relation to the towing vehicle.

19. The apparatus of claim 18, wherein said steering assembly comprises a collar mounted on the drive shaft housing and a steering handle fixed to the collar for moving the drive assembly side-to-side.

20. The apparatus of claim 18, wherein said elevating assembly comprises a rack carried by an exterior of the drive shaft housing and a pinion assembly capable of moving along the rack for raising and lowering the connector arm.

21. The apparatus of claim 18, further comprising a means for moving the drive assembly between an operating position when the drive shaft housing is oriented transverse to the connector arm and a stowaway position wherein the drive shaft housing extends in a substantially parallel relationship to a longitudinal axis of the connector arm.

22. The apparatus of claim 21, wherein said means for moving the drive assembly between an operating position and a stowaway position comprises a tilt base plate secured to the mounting means, a tilting plate pivotally engaged with the tilt base plate and secured to the drive shaft housing, and a pivot pin selectively engageable with the tilt base plate and the tilting plate.

23. The apparatus of claim 22, wherein said pivot pin carries a compression spring normally urging the pivot pin into a locking engagement with the tilt base plate.

24. A connector assembly for a trailer having an elongate connector arm with a front end configured for attachment to a towing vehicle, the connector assembly comprising:
a means for detachably mounting the connector assembly on the connector arm;
a drive assembly pivotally engaged with the mounting means and capable of moving the connector arm toward and away from the towing vehicle, said drive assembly comprising a drive shaft extending in a drive shaft housing, a rotating wheel secured to the lower end of the drive shaft and a power motor for imparting rotation on the rotating wheel;
a steering assembly secured to the drive shaft housing for directing side-to-side movement of the drive assembly; and
an elevating assembly secured on the drive shaft housing and capable of raising and lowering the connector arm in relation to the towing vehicle.

25. The apparatus of claim 24, wherein said steering assembly comprises a steering motor secured to the drive shaft housing.

26. The apparatus of claim 24, wherein said elevating assembly comprises a rack carried by an exterior of the drive shaft housing and a pinion assembly capable of moving along the rack for raising and lowering the connector arm, and an elevating motor for moving the pinion assembly along the rack.

27. The apparatus of claim 24, further comprising a control unit operationally connected to the power motor and a remote control means for sending a control signal to the control unit for operating said power motor.

28. The apparatus of claim 27, wherein said control signal is a wireless signal.
